(19) United States
(12) Patent Application Publication
(10) Pub. No.: US 2013/0045068 A1
(43) Pub. Date: Feb. 21, 2013

(54) GRAVEL INSERT FOR DUMP BODY

(71) Applicant: JOHN L. MARTIN, Whitewater, WI (US)

(72) Inventor: JOHN L. MARTIN, Whitewater, WI (US)

(21) Appl. No.: 13/211,511

(22) Filed: Aug. 17, 2011

(51) Int. Cl. B65G 67/02; B65G 67/04; B65G 67/24

(52) U.S. Cl. 414/346; 414/809

(57) ABSTRACT

Provided is a chute apparatus for a dump body configured to easily transfer material from a dump body directly into a small cargo mover, such as a wheelbarrow. The chute apparatus comprises at least one side wing which may be rotatable with respect to a side wall of the dump body. The chute may further comprise a floor panel, which may be rotatable with respect to the floor of the dump body. When in working position (with side wings rotated in towards the center and the floor panel raised) and dump body titled into a raised position to unload the material, the raised floor panel lifts an exit point where the material is unloaded from the dump body, which allows the small cargo mover to be placed directly in line and preferably under the flow of material from the dump body.

### BACKGROUND OF THE INVENTION

The present invention relates generally to dump bodies used to receive, transport, and unload materials such as gravel, sand, soil, dirt or other industrial, landscaping, and building materials; and more specifically to a chute apparatus for use in a dump body that allows for easy transfer of material from a dump trailer to a smaller cargo mover such as a wheelbarrow or skid loader.

Present methods of emptying materials from a dump body typically require that the material, or fill, contained in the dump body be emptied onto the ground out of the rear end of the tilted dump trailer before being moved into a smaller cargo mover such as a wheelbarrow, or being hand shoveled directly from the dump body in its normal position into the smaller cargo mover. This is a result of there being no practicable way to tilt the dump body for emptying at a height that is conducive to transfer directly into a skid loader or wheelbarrow, since generally, the floor of the dump body will be below the receiving height of cargo mover. Certain improvements have been made to dump trailers and to the emptying process which include various constructions of devices to more precisely direct the flow of the material as it is being emptied from the dump trailer. In some improvements, chutes are formed along the center of a dump trailer to direct the flow of material onto a conveyor to be further, emptied at another location, or by attachment of a chute-like tub at the end of the dump body to allow for transfer into the small cargo mover. As a result, there remains a need for an apparatus that can be used to accommodate easy transfer of the material from the dump body in a titled position directly into a wheelbarrow, skid loader, or other small cargo mover.

### SUMMARY OF THE INVENTION

The present invention satisfies this need by providing a chute apparatus for unloading material from a dump body into a cargo mover comprising at least one side wing having a free end and a support end with free end being positionable away from the side wall of a dump body at an operating angle and means for securing the side wing away from the side wall. The invention also comprises a floor panel having a free end and a support end, with the free end being positionable above the floor of the dump body, with means for maintaining the floor panel in a raised position, in order to position the point at which the fill will exit the dump body above the height of the cargo mover, to accommodate direct transfer into the cargo mover. The invention also includes a method of unloading fill from a dump body directly into a cargo mover comprising the steps of providing the chute apparatus according to the present invention, positioning the chute apparatus into a working position, placing fill in the dump body, positioning the cargo mover proximate to the unloading end of the dump body, tilting the dump body to unload the fill, and directing the fill through the chute apparatus directly into the cargo mover.

### BRIEF DESCRIPTION OF THE DRAWINGS

FIG. 1 is a perspective view of a dump trailer and a chute apparatus according to the present invention being used to empty material from the tilted dump body directly into a wheelbarrow.

FIG. 2 is a top perspective view of a chute apparatus according to the present invention in place while holding material in the dump body.

FIG. 3 is a side elevation view of a dump trailer and a chute apparatus according to the present invention being used to empty material from the tilted dump body directly into a wheelbarrow.

FIG. 4A is an elevation view of a first side wing component of a chute apparatus according to the present invention.

FIG. 4B is an elevation view of a second side wing component of a chute apparatus according to the present invention which may be a mirror image of the side wing of 4A that may be used on the opposing wall of the dump body.

FIG. 5A is an elevation view of an alternative embodiment of the side wing of FIG. 4B, showing the support means being a plurality of pegs.

FIG. 5B is an elevation view of an alternative embodiment of the side wing of FIG. 4B, showing the support means being a plurality of platforms.

FIG. 6 is a perspective view of a rear end of a dump trailer having a chute according to the present invention in working position showing the floor panel raised off the floor of the dump trailer and the side wings angled towards the center axis to form a chute.

FIG. 7 is a top view of a rear end of a dump trailer having a chute apparatus according to the present invention.

FIG. 8 is a perspective view of a rear end of a dump trailer having a chute apparatus with the components of the apparatus in a stowed position.

FIG. 9 is a perspective view of a dump trailer having an alternative embodiment of a chute apparatus according to the present invention.

FIG. 10 shows a dump trailer having an alternative embodiment of the chute apparatus according to the present invention having a floor panel and a single side wing.

FIGS. 11A and 11B are top views of alternative embodiments of the chute apparatus according to the present invention disposed in a dump trailer having the connection members of the side wing and the floor panel in non-aligned configurations.

FIGS. 12A and 12B are elevation views of alternative embodiments of the side wing having different shapes and designs.

FIG. 13 is a perspective view of a pre-constructed chute apparatus according to the present invention that may be inserted into a dump trailer.

FIG. 14 is an elevation view of an alternative embodiment of a side wing according to the present invention, showing a plurality of support means to create adjustable inclines.

FIG. 15A is a diagrammatic side view of a dump body in a neutral, un-tilted position and a floor panel according to the present invention.

FIG. 15B is a diagrammatic side view of a dump body in a tilted position and floor panel according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

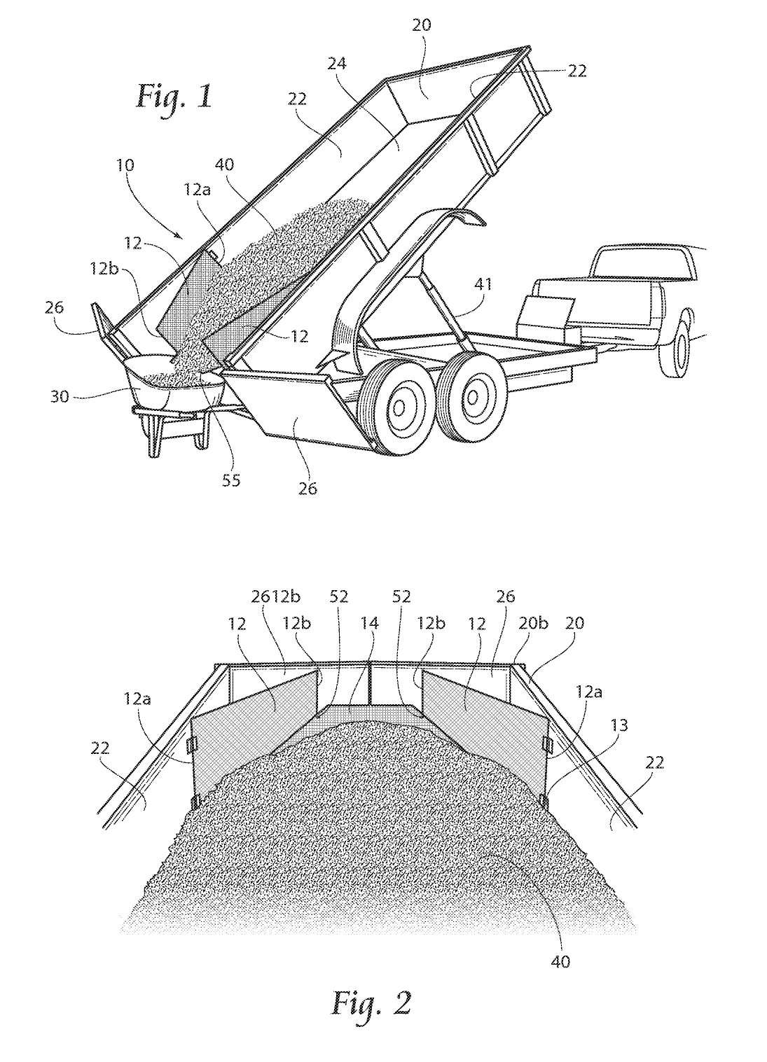

FIG. 1 shows a dump body chute apparatus 10 according to the present invention that may be used to transfer fill 40 (such as gravel, dirt, sand, or any matter that may be moved in a dump body 20) from a dump body 20 into a smaller cargo mover 30, such as a wheelbarrow. As shown, the apparatus 10 has at least one side wing 12. A support end 12a of the side wing 12 is preferably attached to the side wall 22 of the dump body 20 by a bearing that allows some angle of rotation between them, such as at least one metal hinge 13. Alternatively, a side wing 12 may be fixed in place by immovable securing means such as welding, soldering or fasteners such as bolts.

The side wing 12 also preferably has a free end 12b opposite the support end 12a. The hinge(s) 13 may be positioned on the side wall 22 at least substantially perpendicular to the floor 24 such that the free end 12b may be positioned at a plurality of positions about the axis of rotation 15 created by the hinge 13. In a preferred embodiment, when the apparatus 10 is in working position, the free end 12b of the side wing 12 is orientated toward an unloading end 20b of the dump body 20 opposite the support end 12a which is orientated toward a front end 20a of the dump body 20. In this orientation, when the free end 12b is positioned at a chosen position about the axis of rotation 15, an operating angle 19 is formed between the side wing 12 and the side wall 22, in order to direct the fill 40 towards an exit point 55 at the unloading end 20b of the dump body 20. This operating angle 19 may be any selected angle, preferably less than 90°, with the most preferable operating angle 19 being between 30° and 60°.

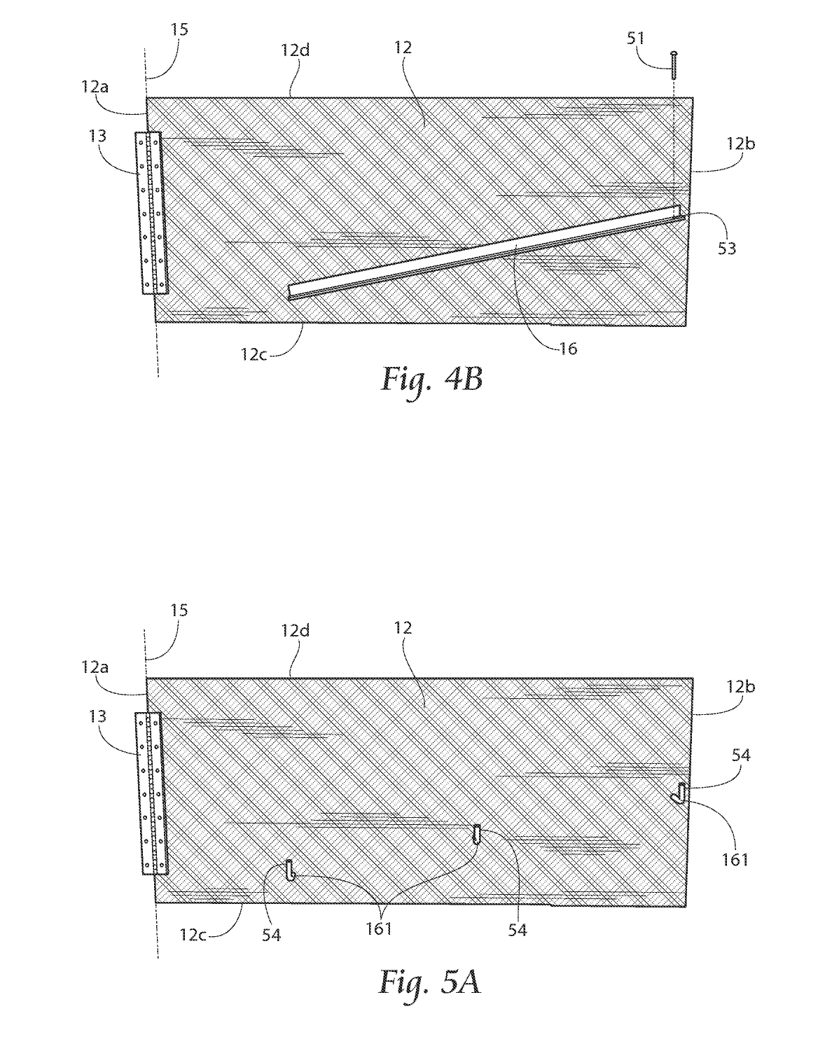

In a preferred embodiment, the apparatus 10 has a pair of side wings 12, connected to opposing walls 22 of the dump body 20. The wings 12 are preferably at least substantial mirror images of the one another, as shown in FIGS. 4A and 4B, but the wings 12 may be different to accommodate different needs or, for example, to save materials by making one smaller than the other or other variations. Alternatively, a chute apparatus 10 having one side wing 12 may used and is within the scope of this invention. This alternative embodiment is shown in FIG. 10.

In the stowed position, shown in FIG. 8, the wing 12 may be held in place against the wall 22 by a latch 56, such as a latch that engages the wall 22 and the side wing 12 to prevent it from swinging away from wall 22 and potential damage during movement of the dump body 20. In this position, the wing 12 may be orientated as discussed above with free end 12b disposed toward the unloading end 20b of the dump trailer 20, relative to the support end 12a. Alternatively, in stowed position, the free end 12b may be orientated toward the front end 20a relative to support end 12b, so long as the wing 12 is rotatable about the axis of rotation 15 so that the free end 12b can be disposed toward the unloading end 20b of the dump body 20 while in working position.

The side wing 12 may be positioned at any point along the wall 22 of the dump body, but in order to minimize the amount of materials needed and to maximize the holding capacity in the dump body 20, the side wing 12 is preferably connected in the rear half of the dump body 20 which is the half nearest to the unloading end 20b of the dump trailer 20. It is preferred that the length 63 of the side wing 12 be substantially equal to the distance 64 between the unloading end 20b of the dump trailer 20 and the support end 12a of the side wing, or that the length 63 of the side wing 12 be six or fewer inches shorter than the distance 64 between the unloading end 20b of the dump trailer 20 and the support end 12a of the side wing 12. Having the side wing 12 terminate within six inches of the unloading end 20b of the dump body 20 when in stowed position, assures that when positioned in its operating angle 19, the free end 12b of side wing 12 is not too far from the unloading end 20b of the dump body 20, and remains effective in directing fill 40 into the cargo mover 30, and may also provide adequate support for the floor panel 14 as the fill 40 is being unloaded.

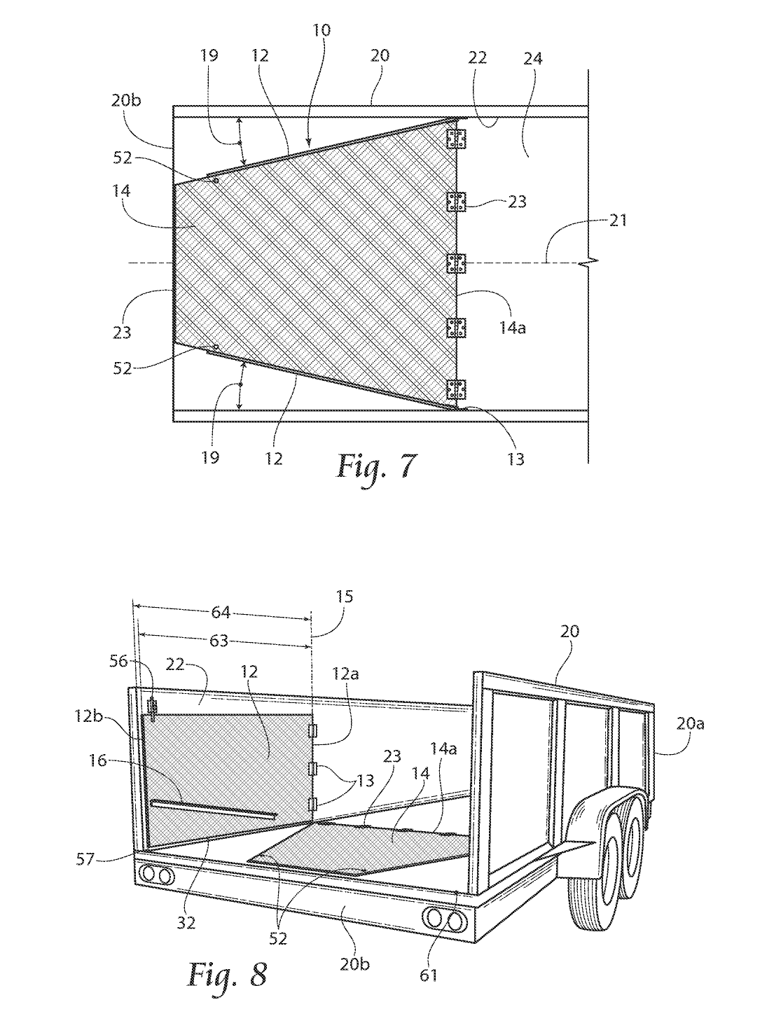

Referring particularly to FIGS. 6-8, the apparatus 10 also preferably has a floor panel 14 that may be attached to the floor 24 of the dump body 20. The floor panel 14 is sized and configured to accommodate interaction with or positioning relative to the side wing 12 in working position (FIG. 6) to form a chute to direct the fill 40 towards the exit point 55, where fill exits off the floor panel 14. In an embodiment shown, the floor panel 14 is trapezoidal in shape, with the non-parallel sides being positioned towards the side walls 22 of the dump body 20, and the parallel sides being positioned parallel to the front end 20a and the unloading end 20b of the dump body 20. The floor panel may also be any suitable shape or construction may be used. The floor panel 14 is preferably attached to the floor 24 at a support end 14a by a bearing that allows some angle of rotation between them, such as a hinge 23 or a plurality of hinges 23. The hinge 23 is preferably at least substantially perpendicular to a center axis 21 of the dump body 20, such that the floor panel 14 may be lifted up from the floor 24, so that the floor panel 14 meets or is positioned with respect to the side wing 12 and forms a chute.

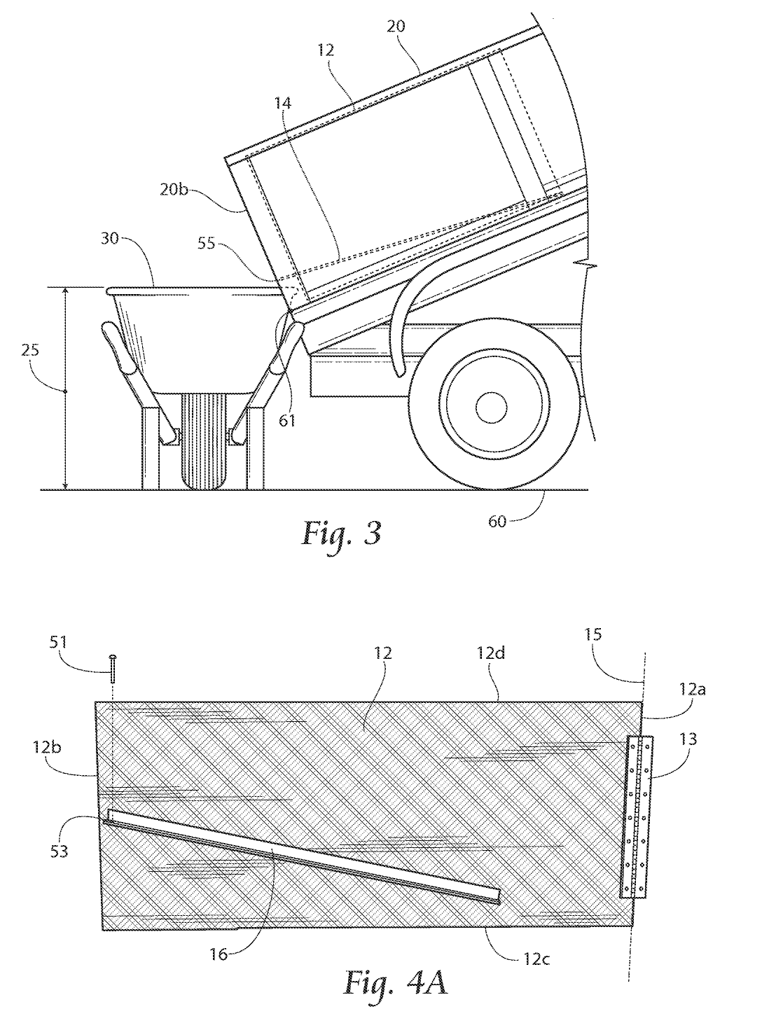

Turning back to FIG. 3, when the dump body 20 is in unloading position, lifting the floor panel 14 from the floor 24 results in the exit point 55 being at a position higher than a receiving height 25 of the cargo mover 30, with the heights being measured from a reference plane 60 which is a substantially planar surface on which the wheels or support of the dump body 20 and the wheels or support of the cargo mover 30 are situated. By lifting the exit point 55 on the floor panel 14 higher than the height 25 of the cargo mover 30, the wheelbarrow, or other cargo mover 30 may be placed directly in line with the flow of fill 40; thereby eliminating the need for the fill 40 to be unloaded onto the ground and then shoveled or otherwise placed into the small cargo mover 30. As can be recognized in the figure, if the fill 40 is not directed by the chute apparatus 10 including the raised floor panel 14, the fill would exit the dump body 20 below the receiving height 25 of the cargo mover 30, thus transfer from the dump body 20 directly to the wheelbarrow 30 would not be viable.

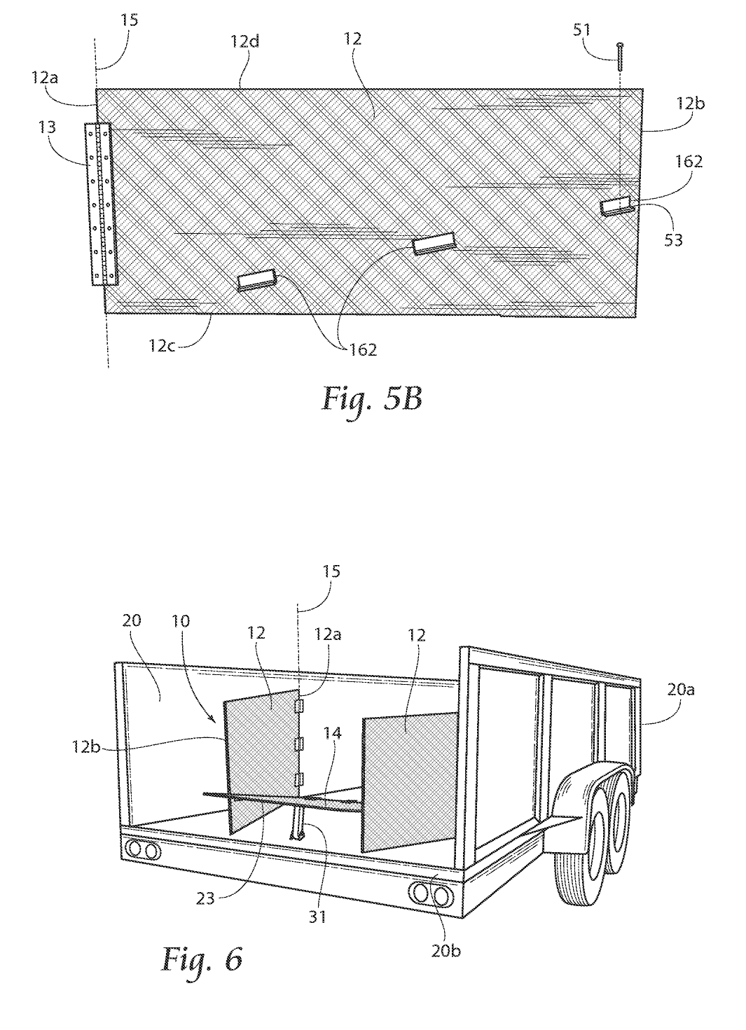

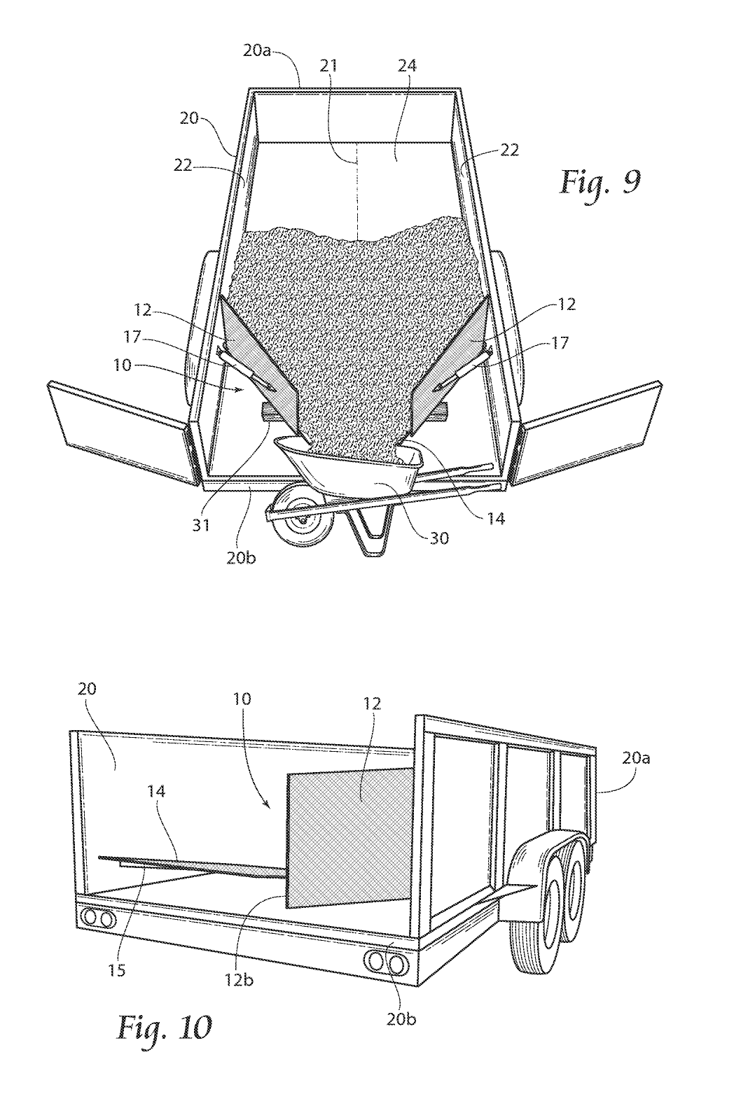

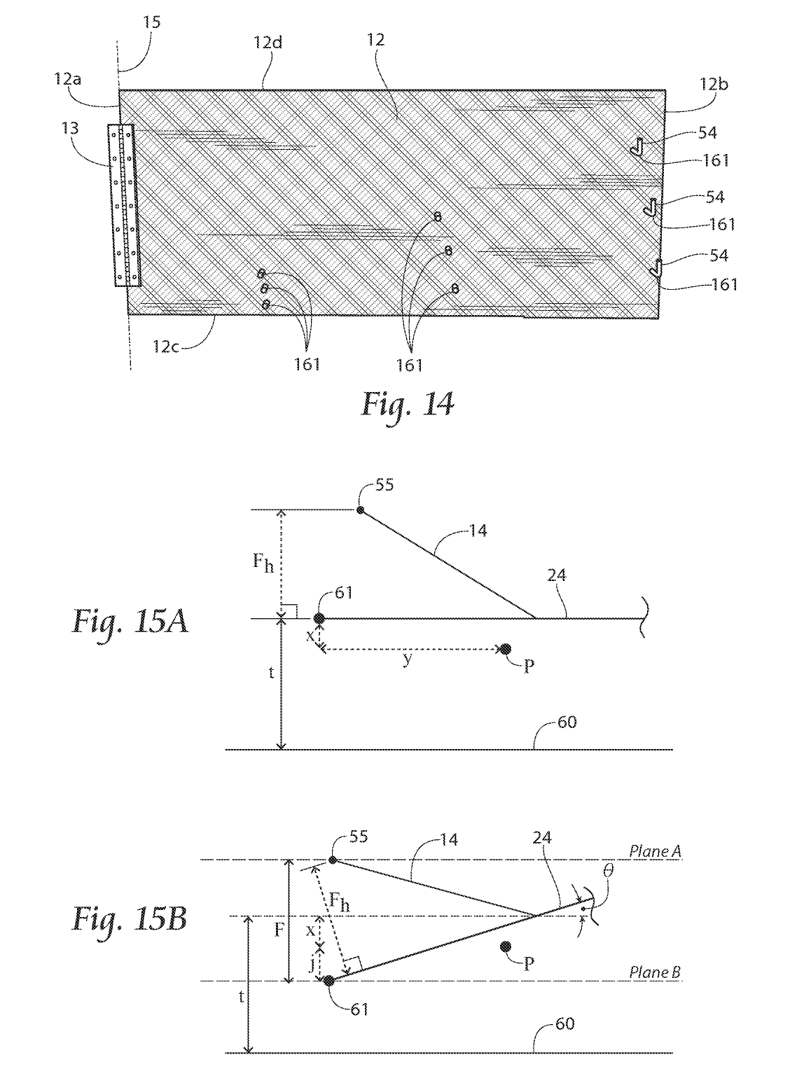

When positioned in working position, the wing 12 is held in place by securing means, which may be a pin 51 that may be insertable through an aperture 52 in the floor panel 14 and an aperture 53 in the support means 16 (discussed below) to secure the floor panel 14 and the side wing 12 to one another or in respective positions, as shown in FIGS. 4A and 4B. Alternatively, the securing means could be a hook 54 on the support means 16, as shown in FIG. 5A and FIG. 14, that is insertable through the aperture 52 in the floor panel 14 that can hookingly engage the floor panel 14 and prevent the side wing 12 from swinging back toward the side wall 22 during unloading. The side wing 12 may also be moveable and securable in position by hydraulics 17 between the side wall 22 and the side wing 12, as shown in FIG. 9.

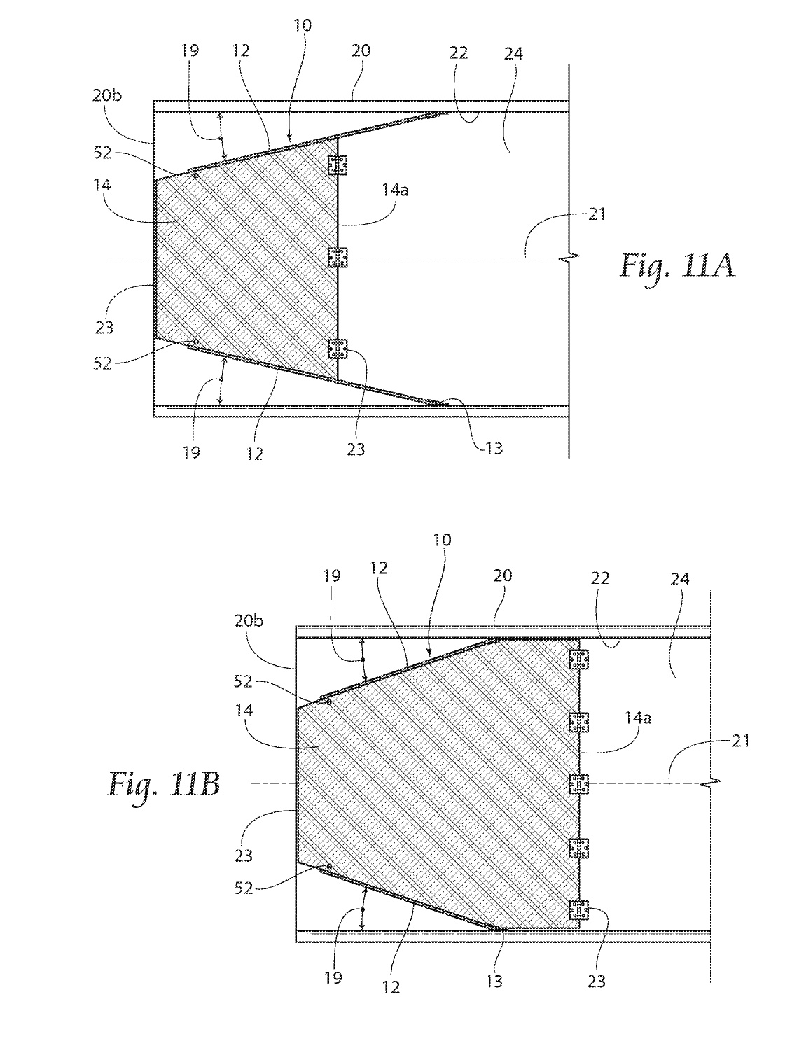

The relationship between the side wing 12 and the floor panel 14 can have a variety of configurations. First, the axis of rotation of the hinges 23 of the floor panel 14 and the axis of rotation 15 of the hinges 13 of the side wings 12 may be aligned on the same plane perpendicular to the center axis 21. Alternatively, as shown in FIGS. 11A and 11B, the hinge(s) 13 and hinge(s) 23 need not be aligned. In addition, the floor panel 14 and the side wing 12 may be sized such that when in working position they terminate at or about the same distance from the unloading end 20b of the dump body 20. Alternatively, as shown, the floor panel 14 may extend slightly beyond the free end 12b of the side wing 12, toward the unloading end 20b of the dump body 20, such that the exit point 55 is closer to the unloading end 20b than is the free end 12b of the side wing 12. This creates a lip which may extend substantially into or towards the cargo mover 30 for more effective transfer of fill 40 into the cargo mover 30. It is preferred that the floor panel 14 and the side wing 12, while in working position, terminate within the dump body 20 no more than 12 inches from the unloading end 20b of the dump body 20, in order to facilitate transfer of fill 40 directly into the cargo mover 30.

As shown in FIGS. 4A-5B, one or each side wing 12 has a support means 16 configured to support the floor panel 14 when the apparatus 10 is moved into working position. The support means 16 may collectively form an inclined support surface, such as a ledge as shown in FIGS. 4A and 4B, or may be one or more pegs 161 or platforms 162 protruding from the side wing 12, or other supporting mechanisms. Some examples of these variations are shown in FIGS. 5A and 5B. The support means 16 is positioned to support the floor panel 14 at a desired incline when it is brought up from the floor 24, such that when in this working position, the floor panel 14, and thus the exit point 55, is positioned higher than a pre-determined receiving height 25 of the cargo mover 30. Typically, small cargo movers such as wheelbarrows have a receiving height of between 20 and 40 inches.

The possible heights from the dump body floor 14 at which the support means 16 or ledge hold the floor panel 14 in working position may be determined by the angle at which the dump body 20 will be tilted in the unloading position and the receiving height 25 of the cargo mover 30. The minimum height at which the floor panel 14 is held by the support means 16 may be determined to position the exit point 55 higher than the receiving height 25 of the cargo mover 30 when the dump body 20 is tilted to its desired unloading position. This may be calculated as shown below as value Fₕ. Accordingly, the height at which the floor panel 14 is positioned may be different for use with various cargo movers 30 of various ° receiving heights 25, and with different dump bodies 20 depending on the maximum of its tilting range, or for different chosen tilting angles of the dump body 20.

Reference to FIGS. 3, 15A and 15B will be useful in the following discussion. In order to achieve the usefulness of the lifted floor panel 14, the height (H_{EP}) of the exit point 55 where the fill 40 leaves the floor panel 14 should be greater than the height 25 (H_{CM}) of the cargo mover 30, both measured perpendicular to horizontal reference plane 60. The height 25 (H_{CM}) of the cargo mover 30 will be known or determinable by the user (and is generally between 20 and 40 inches in an example of a wheelbarrow) and the height (H_{EP}) of the exit point 55 is defined by the equation:

H_{EP}=t−(x+j)+F;

wherein t is the original height of the floor 24 of a dump body 20 in an un-tilted, neutral position, which is the distance between point 61 on the end 20b of the dump body 20 and the reference plane 60 (see FIG. 15A);

(x+j) is the drop in the height of the end point 61 of the dump body 20 when the is tilted, which is calculable as shown below (see FIG. 15B); and

F is an added height (in vertical elevation) between plane A and plane B; wherein plane A is parallel to reference plane 60 and includes exit point 55 at the end of the floor panel 14 and plane B is also parallel to reference plane 60 and includes point 61 on the end 20b of the dump body 20, and (see FIG. 15B).

The goal, as stated just above, is that when the dump body is tilted to a preferred dumping angle θ, H_{EP}≧H_{CM} or that t−(x+j)+F≧H_{CM}. It is noted that if t−(x+j)≧H_{CM} then the floor panel may not be needed to add any height F.

The calculation of x+j is as follows:

x is the vertical difference in height (measured perpendicular to the reference plane 60) between the end point 61 of the dump body 20 and a pivot point P of the dump body 20;

j is calculable by the equation j=c·sin βwherein c=\sqrt{(x²+y²)} where y is the horizontal distance measured parallel to the reference plane 60 between the end point 61 of the dump body 20 and the pivot point P of the dump body 20; and β=θ−α; where θ is the desired tilt angle of the dump body 20 and

$$α = {tan}^{- 1} \frac{x}{y} .$$

Thus, in order to achieve the goal stated above, then F≧H_{CM}−(t−(x+j)) and using the calculations detailed above, the minimum value of F can be determined.

Furthermore, when the dump body is tilted, if it is desirable to position exit point 55 substantially directly above end point 61 (in vertical elevation), as shown in FIG. 15B, the following calculation may be used to determine the height (Fₕ) that the floor panel should be lifted off of the floor 24 (measured perpendicular from the floor 24; see FIGS. 15A and 15B).

Since, in this example,

$$F = \frac{{F}_{h}}{cos θ} ;$$

then,

$$\frac{{F}_{h}}{cos θ} \geq {H}_{CM} - ( t - ( x + j ) ) ;$$

so

Fₕ≧H_{CM}−(t−(x+j))·cos θ

wherein all variables are known, determinable, or calculable as detailed above.

Knowing the desirable range of Fₕ, or the desirable range of F, from the equations above will be the practical way for a user to implement these calculations—to determine what height the floor panel 14 should be lifted from the floor for unloading of the dump body 20 directly into the cargo mover 30.

A wing 12 may have support means 16 designed to support the floor panel 14 at a single height, or may have support means 16 configured to support the floor panel 14 at a plurality of heights. This may be accomplished by a single support means 16 that may be movable, or by a plurality of support means 16 provided at varying positions, as shown in FIG. 14.

In a second embodiment, shown in FIG. 9, the floor panel 14 may be held in a raised position by one or more support members 31 positioned between the floor panel 14 and the floor 24. This embodiment may have the support means 16 on the side wing 12 for added support, or may use only the support member 31 to hold the floor panel 14 in the raised position. The support member 31, may be a block that is either substantially permanently positioned under the floor panel 14 or may be placed under the floor panel 14 for positioning the apparatus into working position, as shown in FIG. 9. Alternatively, the support member 31 may be an additional element that originate from either the floor 24 or the floor panel 14 and may be movable into a position capable of supporting the floor panel 14, as shown in FIG. 6.

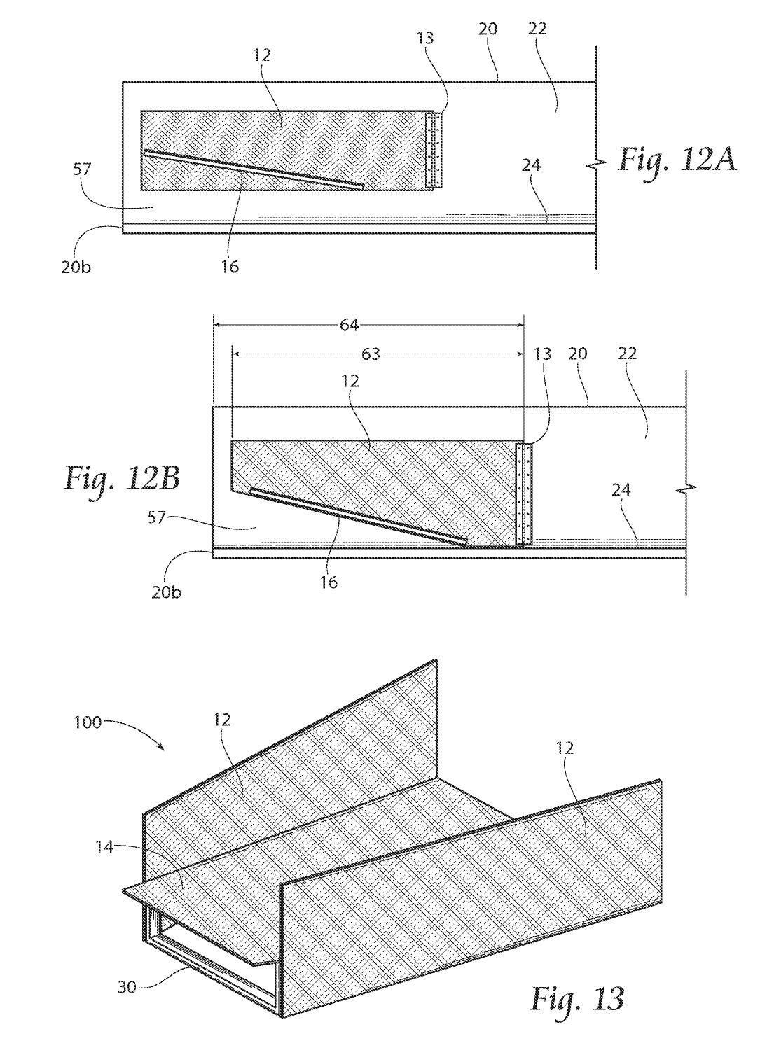

The side wings 12 may be a variety of shapes and sizes. In one embodiment, the wings 12 may be substantially rectangular with the bottom edge 12c being disposed preferably at least substantially parallel to the floor 24 of the dump body 20 and a top edge 12d being at least substantially parallel to a bottom edge 12c. Additional shapes and sizes are possible, such as those shown in FIGS. 12A and 12B. It is not required that the top edge 12d of the side wing 12 reach to the top of the side wall 22 or the bottom edge 12c reach to the floor 24, or that the top edge 12d and bottom edge 12c be parallel to the floor 24, as shown in the examples of FIGS. 12A and 12B, but it is preferred that the side wing 12 reach at least high enough above the floor panel 14 (while elements are in the working position) to contain the fill 40 that is being moved through the chute apparatus 10, and not allow the fill 40 to spill over the top edge 12d of the side wing 12. The shape and size of the side wing 12 is not limited to the possible alternative embodiments shown in the FIGS. 12A and 12B. In any of the side wing 12 variations, it is preferable that there be a slight offset 57 from the floor 14 so that the wing 12 can move without being blocked by any fill 40 that may be on the dump body floor 24.

The width of the chute at the exit point 55 formed by the side wing 12 and floor panel 14 may also be variable, which may be beneficial for use with cargo movers 30 of different sizes. For example, the floor panel 14 could be a square shape and used in conjunction with a side wing 12, such as the one shown in FIG. 12B, and hydraulics 17 to move and secure the panels in working position. In this embodiment, various widths at the exit point 55 could be achieved, using the same floor panel 14 and side wing 12, by changing the operating angle 19 of the side wing 12.

The side wing 12 and floor panel 14 of the present invention are preferably constructed of aluminum diamond plate, which is known to be easy to cut, drill, and form, and is also relatively inexpensive and widely available. The aluminum diamond plate also does not rust and it is lightweight. Alternatively, the side wing 12 and floor panel 14 may be any rigid material that is capable of supporting the weight and related forces of the fill 40 during use, such as steel, smooth aluminum plate, or other similar materials.

The chute apparatus 10 of the present invention may be manufactured as an accessory that can attach, via the connection bearings 13 or hinges, to existing and presently used dump body trailers, or the wing 12 and floor panel 14 could be built directly into dump body trailers at manufacturing. Additionally, the full chute apparatus 100, such as the one shown in FIG. 13, could be constructed with the side wings 12 and floor panel 14 pre-positioned in working position, and the full apparatus 100 could be inserted into the dump body 20 as a unit when needed or desired. In an embodiment shown, the unit 100 may be attached to the dump body 20 by means of support beams 30 constructed between the side wings 12, but various attachment means and designs may be used, such as attaching only the support end 12a of the side wing 12 and/or the support end 14a of the floor panel 14; having planar support bases to attach to either the side wall 22 of the dump body 20, or to the floor 24 of the dump body; or other attachment means. This pre-constructed unit 100 could be inserted into a dump body 20 and remain in the dump body 20 for a single use, or it may remain in the dump body 20 for multiple uses.

The present invention further includes a method for unloading fill 40 from a dump body 20 directly into a small cargo mover 30. The chute apparatus 10, as discussed above, may be provided and may be introduced to a dump body 20. The floor panel 14 may be raised from the floor 24 and the side wing 12 may brought in from the side wall 22, by hydraulics 17 or by manual movement, to attain the working position wherein the floor panel 14 is secured into position, either on the support block 31 or the support means 16 of the side wing 12. The wings 12 may be secured into position by securing means such as inserting a pin 51 through an aperture 52 in the floor panel 14 and an aperture 53 in the support means 16. The dump body 20 preferably has doors 26 or other enclosing means at the unloading end 20b of the dump body 20 which may be closed to retain the fill 40 within the dump body 20 during filling, transport, or whenever the dump body 20 is not unloading the fill 40. The doors 26 are then opened to unload fill 40 from the dump body 20. Prior to unloading, the small cargo mover 30 may be placed in position at the unloading end 20b of the dump body 20 and the dump body 20 may be moved into an unloading position by one or more hydraulic lift cylinders 41, or other raising apparatuses. The fill 40 may be then directed through the chute apparatus 10, between the side wings 12 and along the top of the floor panel 14 at the exit point 55 into the cargo mover 30.

Also provided is a method of determining the height Fₕ at which to lift the floor panel 14 for use in connection with a dump body 20 using the equations set forth above.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A chute apparatus for unloading material from a dump body into a cargo mover, said dump body having a first side wall and a second side wall substantially parallel to one another, a floor disposed between said first side wall and said second side wall, a front end extending between said first side wall and said second side wall, an unloading end disposed between said first side wall and said second side wall, opposite said front end, and a center axis extending from said front end to said unloading end uniformly spaced between said first side wall and said second side wall, and said dump body capable of maintaining a neutral position and a tilted position, said apparatus comprising:
a side wing having a support end and a free end, wherein said support end is disposed adjacent to said first side wall, and wherein said free end is positionable away from said first side wall towards said center axis and between said support end and said unloading end, creating an operating angle between said side wing and said first side wall;
a floor panel disposed between said at least one side wing and said second side wall, said floor panel having a support end and a free end wherein said support end is disposed adjacent to said floor of said dump body and said free end can be lifted from said floor into a raised position;
a support means for maintaining said floor panel in said raised position; and
means for securing said side wing at said operating angle.

2. A chute apparatus according to claim 1 wherein said support end of said side wing is disposed adjacent to said side wall substantially perpendicular to said floor.

3. A chute apparatus according to claim 1 wherein said side wing is rotatably attached to said side wall.

4. A chute apparatus of claim 3 wherein said side wing is rotatable about an axis of rotation that is substantially perpendicular to said floor.

5. A chute apparatus according to claim 3 wherein said side wing is attached to said side wall by at least one hinge.

6. A chute apparatus according to claim 1 comprising a second side wing having a support end and a free end, wherein said support end of said second side wing is disposed adjacent to said second side wall, and wherein said floor panel is disposed between said first side wing and said second side wing.

7. A chute apparatus according to claim 6 wherein said first side wing and said second side wing are substantially identical mirror images of one another.

8. A chute apparatus according to claim 1 wherein said side wing has a first side and second side, wherein said first side is the side disposed towards said floor panel, and wherein said support means for maintaining said floor panel in said raised position is affixed to said first side of said side wing.

9. A chute apparatus according to claim 8 wherein said support means is at least one elongated ledge.

10. A chute apparatus according to claim 8 wherein said support means is at least one projection from said first side of said side wing.

11. A chute apparatus according to claim 1 wherein said support means is a support component disposed between said floor panel and said floor of said dump body.

12. A chute apparatus according to claim 1 wherein said means for securing is at least one hydraulic apparatus.

13. A chute apparatus according to claim 1 wherein said means for securing is a pin apparatus that extends through an aperture in said floor panel and an aperture in said support means.

14. A chute apparatus according to claim 1 wherein said means for securing is a hook apparatus that extends through an aperture in said floor panel.

15. A chute apparatus according to claim 1 further comprising an exit point at said free end of said floor panel, wherein when said floor panel is in said raised position and said dump body is in said tilted position, the position of the exit point is above said cargo mover.

16. A chute apparatus according to claim 15 wherein said position of said exit point is at a height that can be calculated by the equation:
H_{EP}=t−(x+j)+F;
wherein all measurements are made substantially perpendicular to a reference plane on which said dump body and said cargo mover are situated, and further wherein t is the height of said unloading end of said dump body when said dump body is in said neutral position measured from said reference plane, (x+j) is the calculable difference in height from t of said unloading end of said dump body when said dump body is in said tilted position, and F is the vertical height of said exit point measured from said unloading end of said dump body.

17. A chute apparatus according to claim 16 wherein said exit point of said floor panel is positionable at a height Fₕ measured perpendicular to said floor of said dump body according to the equation:
$${F}_{h} \geq \frac{{H}_{CM} - ( t - ( x + j ) )}{cos θ} ;$$
wherein H_{CM} is the height of said cargo mover and θ is a calculable portion of a total tilt angle of said dump body in said tilted position.

18. A chute apparatus according to claim 1 wherein said side wing and said floor panel in said raised position are permanently attached to one another to form a unitary piece.

19. A method of unloading fill from a dump body directly into a small cargo mover, said dump body having a first side wall and a second side wall substantially parallel to one another, a floor disposed between said first side wall and said second side wall, a front end extending between said first side wall and said second side wall, an unloading end disposed between said first side wall and said second side wall, opposite said front end, and a center axis extending from said front end to said unloading end uniformly spaced between said first side wall and said second side wall, and said dump body capable of maintaining a neutral and a tilted position, said method comprising the steps of:
providing a chute in a dump body, said chute comprising a side wing having a support end and a free end, wherein said support end is disposed adjacent to said first side wall, and wherein said free end is positionable away from said first side wall towards said center axis and between said support end and said unloading end creating an operating angle between said side wing and said first side wall;
a floor panel disposed between said at least one side wing and said second side wall, said floor panel having a support end and a free end, wherein said support end is attachable to said floor of said dump body and said free end, defining an exit point, can be lifted from said floor into a raised position;
a support means for maintaining said floor panel in said raised position; and
a means for securing said side wing at said operating angle;
lifting said exit point of said floor panel into a position that is above said cargo mover when said dump body is in said tilted position;
moving said free end of at least one side wing away from said side wall towards said center axis to form said operating angle;
holding said floor panel in said raised position with said support means;
securing said side panels at said operating angle with said means for securing;
placing fill in said dump body;
positioning said small cargo mover proximate to said unloading end of said dump body;
tilting said dump body into said unloading position to position at least a portion of said chute vertically above said cargo mover;
directing fill through chute into said small cargo mover.

20. The method of claim 19 wherein said placing step is performed after said holding and said securing steps.
